(19) United States
(12) Patent Application Publication
(10) Pub. No.: US 2005/0127764 A1
(43) Pub. Date: Jun. 16, 2005

(54) Electric feed-through motor

(76) Inventors: Eric Stephen Mattis, San Diego, CA (US); Thomas J. Benacka, Solana Beach, CA (US)

Correspondence Address: Qualcomm Incorporated;Patents Department, 5775 Morehouse Drive, San Diego, CA, 92121-1714, US

(21) Appl. No.: 10/658,300

(22) Filed: Sep. 8, 2003

(51) Int. Cl. H02K 11/00

(52) U.S. Cl. 310/68 R; 310/67 R

(57) ABSTRACT

An apparatus for providing electrical coupling, comprising a motor having a hollow, rotational shaft; and, in one embodiment, an electrical conductor located within said shaft for providing electrical signals through the motor.

### I. FIELD

The present invention pertains generally to the field of motors and electrical circuits, and more specifically to a motor for providing an electrical feed-through to a rotating object.

### II. BACKGROUND

Electric motors have been used for many years, for instance, to rotate antenna platforms. In many instances, antennas are mounted to a structure commonly known as a turntable. An electric motor is mounted underneath the turntable and attached thereto, and is used to rotate the turntable and, hence, the antenna, to maximize the antenna signal strength.

The turntable rotates with respect to the motor and any circuitry not located on the turntable. Hence, there is a need to couple electrical signals to the rotating antenna platform. Traditionally, this has been accomplished by use of a rotational coupler, which is a device that rotates with respect to fixed circuitry yet allows electrical signals to be transmitted from the fixed circuitry and onto one end of a rotating member of the rotational coupler. The other end of the rotational coupler is typically fixed to, for instance, circuitry located on the turntable.

The use of a rotary coupler typically demands that the motor be located off-axis from the central axis about which the turntable rotates. One or more belts, gears, or similar devices is used to couple rotational energy from the motor to a pulley attached to the turntable, thereby causing the turntable to rotate.

Generally, the location of the motor off-axis presents several problems. Often, there is limited space for a motor to be mounted anywhere in an antenna structure, so it becomes a challenge to fit all necessary electrical components and the motor onto the surface of the base. Locating the motor along the central rotating axis of the turntable would be ideal, however it is necessary to locate the rotational coupler in that particular area, due to the physical constraints of the rotational coupler.

Additionally, the reliability of such an antenna system is diminished somewhat, due to the use of the belt or gears, which can wear out, break, or slip in relation to the motor or the pulley to which it is attached.

What is needed is a way to locate the motor along the turntable central axis and attach it directly to a turntable, platform, or antenna, while still providing electrical signals to and from the turntable, platform, or antenna.

### SUMMARY

An apparatus for providing electrical coupling, comprising a motor having a hollow, rotational shaft, and an electrical conductor located within said shaft.

### BRIEF DESCRIPTION OF THE DRAWINGS

FIG. 1 illustrates an isometric, exploded, cutaway view of an antenna assembly using a feed-through motor;

FIG. 2 illustrates a close-up, isometric, exploded, cutaway view of one embodiment of the feed-through motor of FIG. 1; and

FIG. 3 illustrates the antenna assembly of FIG. 1, shown in a cross-sectional view.

### DETAILED DESCRIPTION

The embodiments described herein are described with respect to an electric motor, commonly used to rotate antenna platforms. However, it should be understood that the motor could alternatively comprise any type of motor, including those driven by means other than electrical signals. In addition, the embodiments described herein may be used in applications other than antenna assemblies, such as in automotive applications, computer applications, or any other application where it is desirous to transmit an electrical signal to a rotatable platform.

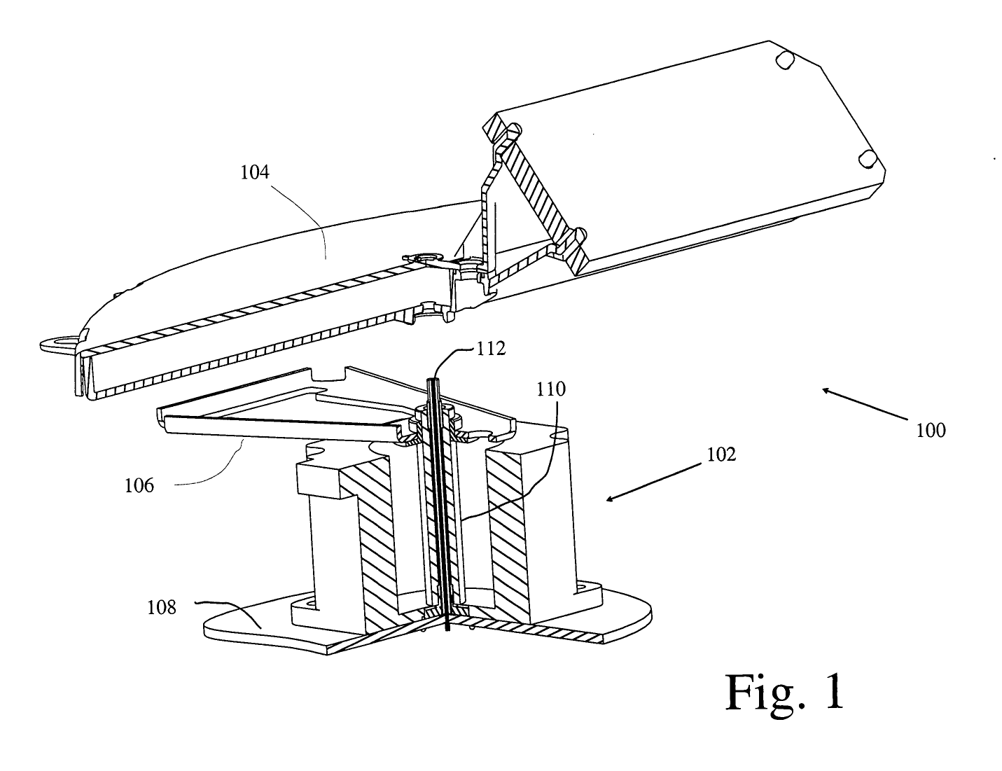

FIG. 1 illustrates an isometric, exploded, cutaway view of an antenna assembly 100, comprising motor 102, antenna horn 104, platform 106, and circuit board 108. Motor 102 is mounted against circuit board 108 and is used to rotate platform 106 and antenna horn 104 when assembled. Motor 102 comprises shaft 110 which, in one embodiment, comprises conductor 112. One end of conductor 112 is electrically connected to circuit board 108 while the other end of conductor 112 extends into a cavity formed by platform 106 and antenna horn 104 when assembled. Shaft 110 is connected to platform 106, enabling platform 106 and antenna horn 104 to rotate about an axis around shaft 110. Conductor 112 resides within shaft 110 and, in this embodiment, is not connected to shaft 110. Therefore, conductor 112 remains stationary as shaft 110 rotates about its axis.

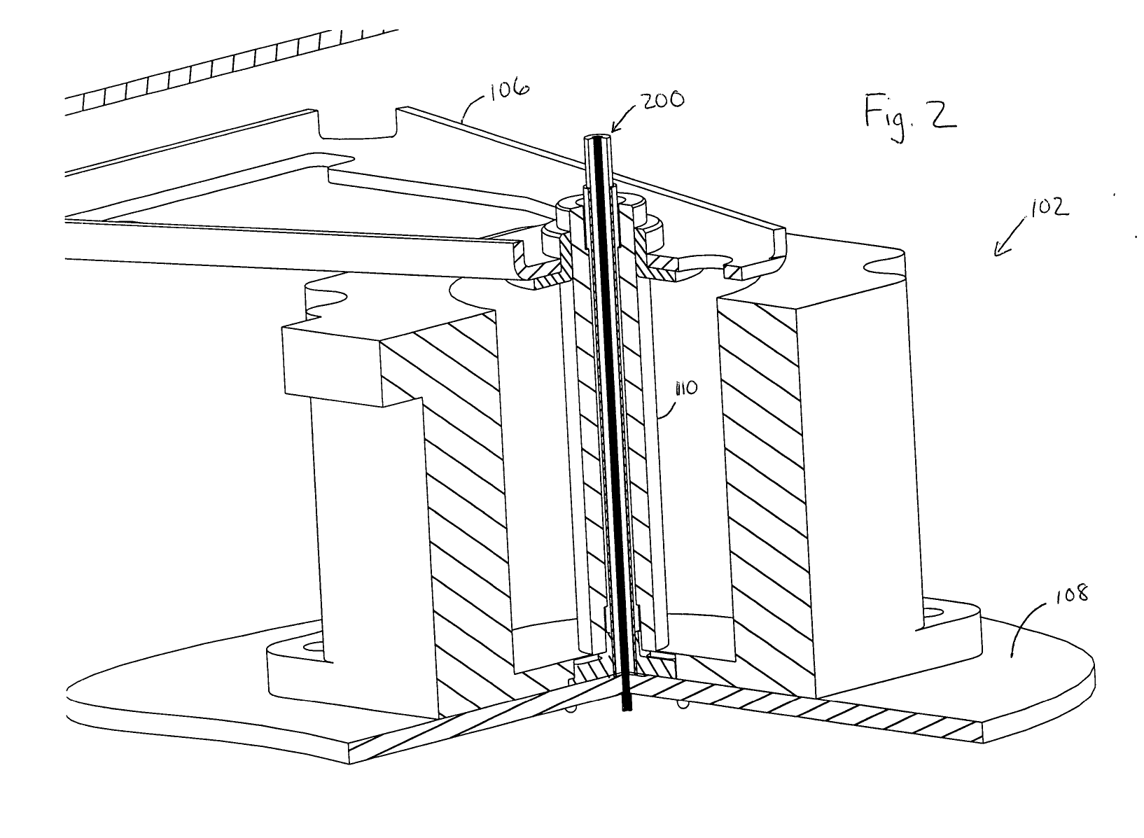

FIG. 2 illustrates a close-up, isometric, exploded, cutaway view of one embodiment of the feed-through motor of FIG. 1. In this embodiment, a semi-rigid coaxial cable 200 is housed inside shaft 110. Shaft 10 is rotated about a central axis by an electromagnetic force generated by exciting windings of motor 102. Shaft 110 is additionally connected to platform 106 which in turn provides a bottom portion of a horn antenna assembly (not shown). Coaxial cable 200 extends past a top portion of shaft 110, exposing coaxial cable 200 to a cavity formed by the platform 106 and the horn antenna assembly. The other end of coaxial cable 200 extends past a lower portion of shaft 110, through motor 102, and through circuit board 108 where it is electrically connected to electronic circuitry used to generate and receive high frequency electronic transmissions.

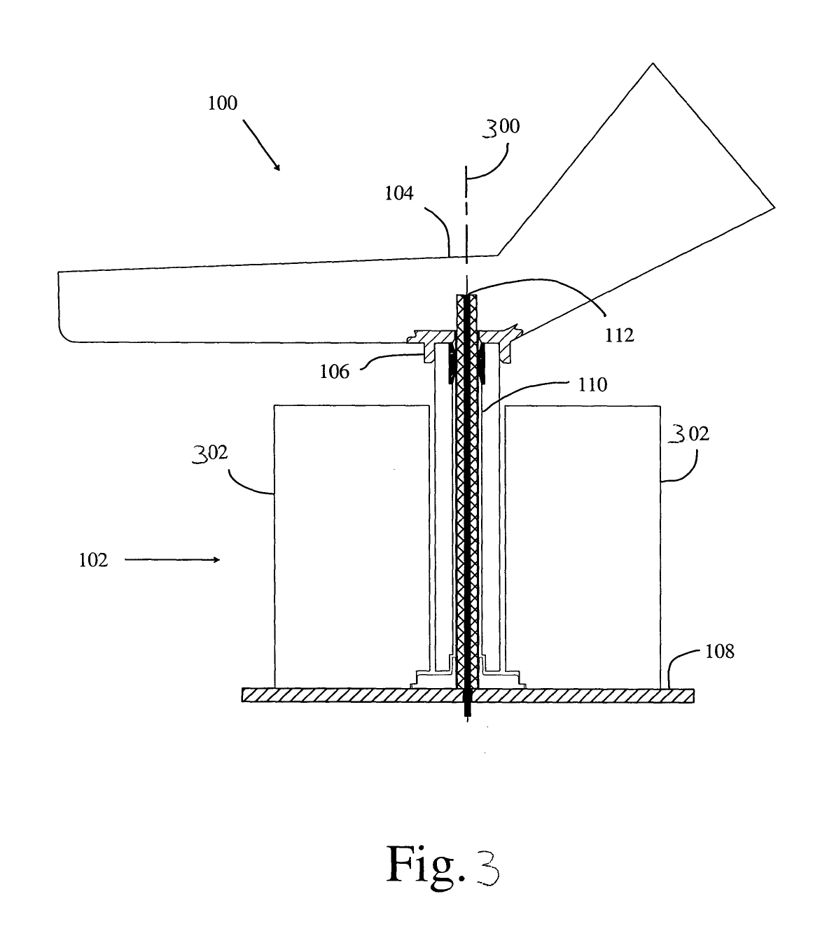

FIG. 3 illustrates the antenna assembly 100 of FIG. 1, shown in a cross-sectional view, including motor 102 in accordance with one embodiment of a feed-through motor. Motor 102 in this example comprises a stepper motor, however any type of motor could be used alternatively, including a D.C. brush or brushless motor, a servo motor, a brushless servo motor, and others, including motors that are driven by means other than electricity, such as a gasoline-powered motor.

As mentioned with respect to FIG. 1, the antenna assembly 100 comprises motor 102, antenna horn 104, platform 106, and circuit board 108. The antenna horn 104 rotates about an axis 300 as shown to allow it to maximize the signal strength of high-frequency signals received by antenna horn 104. It should be understood that any other type of rotatable assembly could be used in place of antenna horn 104, such as a circuit board for receiving electric signals through motor 102 or any other type of mechanical assembly.

Motor 102 comprises stator 202, hollow shaft 110, and, in one embodiment, conductor 112. Shaft 110 is rotated with respect to stator 302 using principles well-known in the motion-control art. For example, shaft 110 may be rotated to any position using motor-control circuitry (not shown) in accordance with generally-known stepper motor principles.

Shaft 110 comprises a hollow, cylindrical member, able to rotate with respect to stator 302. Shaft 110 may be formed by drilling or by any other means known in the art. In one embodiment, motor 102 is constructed with conductor 112 located within shaft 110. In other embodiments, motor 102 is constructed without conductor 112, the conductor 112 inserted or otherwise introduced through shaft 110 during a later time, such as the mounting of motor 102 onto circuit board 108. Conductor 112 functions to provide electrical signals from circuit board 108 to antenna horn 104. For example, in one embodiment, shaft 110 comprises a conductor which is used to pass electrical signals. In the example of FIG. 3, one end of conductor 112 is connected to circuit board 108 by any convenient means, such as soldering. Alternatively, or in addition, conductor 112 is electrically coupled to circuitry located on circuit board 108. The other end of conductor 112 extends into a cavity of antenna horn 104 and, in this embodiment, remains unconnected from any physical portion of antenna horn 104.

In one embodiment, conductor 112 is not connected to shaft 110 so that conductor 112 remains stationary as shaft 110 rotates, and therefore antenna horn 104, about axis 300. In another embodiment, conductor 112 is affixed to shaft 110 and rotates along with shaft 110 around axis 300. In this embodiment, at least one end of conductor 112 comprises a rotary coupling. For example, a rotary coupling is needed at the juncture of a signal source located on or within circuit board 108 (such as a circuit trace, microstrip, or waveguide coupler) and conductor 112. In other applications where both ends of conductor 112 are connected to a mechanical structure, such as a circuit board, two rotational couplers are needed, one located at the juncture of a signal source located on or within circuit board 108 (such as a circuit trace, microstrip, or waveguide coupler) and one needed at the opposite end of conductor 112 where conductor 112 attaches to a mechanical structure, such as a turntable, platform, or directly to antenna horn 104.

In embodiments where conductor 112 is affixed to the shaft and rotates therewith, conductor 112 may comprise a flexible, rigid, or semi-rigid coaxial cable. Such a coaxial cable typically comprises a non-conductive sleeve surrounding a conductor, dielectric, and shield. The sleeve may be held fixedly within shaft 110 by an adhesive, by press fitting, or by any other means generally known in the art. In an embodiment where a non-conducting sleeve is not used, such as the case of some rigid or semi-rigid coaxial cables, the shield may be connected directly to the shaft from within, held in place by an adhesive, by press fitting, soldering, welding, or any other means generally known in the art. In still another embodiment, shaft 110 forms the shield of the coaxial cable, wherein a dielectric and center conductor are located within shaft 110. In yet another embodiment, shaft 110 comprises a waveguide.

Conductor 112 comprises any electrical conductor known in the art including an insulated or non-insulated wire, a coaxial cable, a waveguide, or a combination thereof. Electrical signals carried by conductor 112 may comprise digital or analog signals, from D.C. to microwave frequencies and beyond.

The advantages of this design allows motor 102 to be located along an axis of rotation of platform 106/antenna horn 104, thereby freeing space on circuit board 106 for other components. In addition, one or more drive belts, used in applications where a motor is located off-axis, are eliminated, adding to the reliability of antenna assembly 100.

The preferred embodiments of the present invention have thus been shown and described. It would be apparent to one of ordinary skill in the art, however, that numerous alterations may be made to the embodiments herein disclosed without departing from the spirit or scope of the invention. Therefore, the present invention is not to be limited except in accordance with the following claims.

1. An apparatus for providing electrical coupling, comprising:
a motor having a hollow, rotational shaft for allowing electrical signals to pass there through.

2. The apparatus of claim 1, wherein said shaft comprises a conductor, the shaft for conducting electrical signals through said motor.

3. The apparatus of claim 1, further comprising an electrical conductor located within said shaft for providing said electrical signals through said motor.

4. The apparatus of claim 3 wherein the electrical conductor comprises a coaxial cable.

5. The apparatus of claim 3 wherein the electrical conductor comprises a rotational coupler.

6. The apparatus of claim 3 wherein the electrical conductor comprises a wire.

7. The apparatus of claim 1 wherein the shaft comprises a waveguide.

8. The apparatus of claim 7, wherein the shaft additionally comprises a waveguide coupler.

9. The apparatus of claim 1, further comprising a rotational coupler for coupling said electrical signals between a second conductor and the conductor.

10. The apparatus of claim 1, further comprising a platform connected to the shaft, wherein the conductor is fixed with respect to the shaft.

11. The apparatus of claim 1, further comprising a platform connected to the shaft, wherein the conductor is affixed to the shaft and rotates therewith.

12. The apparatus of claim 3, wherein the coaxial cable comprises an outer conductor, a dielectric, and a center conductor, wherein the dielectric and the center conductor are fixed, and the outer conductor is fixed to said shaft.

13. The apparatus of claim 1, wherein said shaft comprises:
a dielectric material within said shaft and affixed thereto; and
a center conductor within said dielectric material.
